(19) United States
(12) Patent Application Publication
(10) Pub. No.: US 2023/0313558 A1
(43) Pub. Date: Oct. 5, 2023

(54) Sanitary Changeable Doorknob Covers

(71) Applicant: Almus Wilson, Jamaica, NY (US)

(72) Inventor: Almus Wilson, Jamaica, NY (US)

(21) Appl. No.: 17/937,820

(22) Filed: Oct. 4, 2022

Related U.S. Application Data
(60) Provisional application No. 63/327,149, filed on Apr. 4, 2022.

(51) Int. Cl. E05B 1/00; G09F 23/00

(52) U.S. Cl. CPC E05B 1/0069; E05B 1/0061; G09F 23/0081

(57) ABSTRACT

The present invention relates to a sanitizing doorknob cover device that sanitizes the device and a hand of a user after each use. The device is primarily comprised of a body having at least one disinfection compound and a first end with an opening. The device functions as a doorknob cover, wherein the disinfection compound is impregnated within the body, such that the compound excretes from the body when the device is grabbed. As a result, the device sanitizes the hand of the user and also the surface of the device each time the device is grabbed.

### CROSS-REFERENCE TO RELATED APPLICATION

The present application claims priority to, and the benefit of, U.S. Provisional Application No. 63/327,149, which was filed on Apr. 4, 2022, and is incorporated herein by reference in its entirety.

### FIELD OF THE INVENTION

The present invention relates generally to the field of doorknob covers. More specifically, the present invention relates to a sanitizing doorknob cover device primarily comprised of a body having at least one disinfection compound and a first end with an opening. The device functions as a doorknob cover, wherein the disinfection compound is impregnated within the body, such that the compound excretes from the body when the device is grabbed. As a result, the device sanitizes the hand of the user and also the surface of the device each time the device is grabbed. Accordingly, the present disclosure makes specific reference thereto. Nonetheless, it is to be appreciated that aspects of the present invention are also equally applicable to other like applications, devices, and methods of manufacture.

### BACKGROUND

Many individuals do not and/or forget to wash and sanitize their hands on a regular basis. This ultimately results in illnesses being spread via surfaces that are touched by said individuals. One such surface includes a doorknob. As a result, germs, viruses, and bacteria are commonly transferred from person to person via doorknobs. To prevent this, many establishments attempt to sanitize doorknobs. However, as a practical matter, doorknobs cannot be sanitized after being touched by every individual.

Therefore, there exists a long-felt need in the art for a device that prevents germs, viruses, and bacteria from being spread via a doorknob. There also exists a long-felt need in the art for a sanitizing doorknob cover device that sanitizes a doorknob in between uses. Further, there exists a long-felt need in the art for a sanitizing doorknob cover device that sanitizes each user's hand that grabs the doorknob. In addition, there exists a long-felt need in the art for a sanitizing doorknob cover device that operates passively. Finally, there exists a long-felt need in the art for a sanitizing doorknob cover device that fits any doorknob size and shape known in the art.

The subject matter disclosed and claimed herein, in one embodiment thereof, comprises a sanitizing doorknob cover device. The device is primarily comprised of a body having at least one disinfection compound and a first end with an opening. The device can be placed over a doorknob to function as a doorknob cover. The disinfection compound is preferably impregnated within the body, such that the compound excretes from the body when the device is grabbed. Therefore, the device sanitizes the hand of the user and also sanitizes the surface of the device each time the device is grabbed. The disinfection compound may be any antibiotic, antiseptic, disinfectant, sanitizer, etc., known in the art.

In this manner, the sanitizing doorknob cover device of the present invention accomplishes all of the foregoing objectives and provides a device that can be used on any doorknob to prevent germs, viruses, and bacteria from being spread via a doorknob. To accomplish this, the device sanitizes a doorknob in between uses and sanitizes each user's hand that grabs the doorknob. In addition, the device does so passively.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a sanitizing doorknob cover device primarily comprised of a body having at least one disinfection compound and a first end with an opening. The body is sized and shaped to fit any style, size, fit and/or finish of doorknob known in the art and is comprised of a first end with at least one opening that allows the device to be positioned and stretched over an existing doorknob. The body may also be comprised of a second end with at least one opening that allows the lock of the doorknob to be accessed while the device is applied to a doorknob.

In one embodiment, the interior surface of the body is recessed and/or ridged to promote grip and prevent slipping between the body and the doorknob while the device is placed over a doorknob. In a differing embodiment, the interior surface may be comprised of at least one fastener that secures the interior surface of the body to the doorknob. The exterior surface may also be recessed and/or ridged to promote grip and prevent slipping between a user's hand and the device while grasping the doorknob.

The exterior surface of the body is preferably permeable, such that the disinfection compound can be excreted from the body when the body is grasped by the hand of the user. In another embodiment, the compound is comprised of a coating (with at least one layer) applied to the exterior surface of the body. However, the compound is preferably impregnated into the body (and/or exterior surface) during the manufacturing process. The compound is also preferably a disinfecting compound known in the art such as, but not limited to, antibiotics, antiseptics, disinfectants, sanitizers, etc. Therefore, a user's hand is disinfected after touching the device via the transfer of the compound from the exterior surface and/or body to the user's hand. In addition, the body is also disinfected by the compound as this occurs.

Accordingly, the sanitizing doorknob cover device of the present invention is particularly advantageous as it provides a device that can be used on any doorknob to prevent germs, viruses, and bacteria from being spread via a doorknob. During use, the device sanitizes a doorknob in between uses and sanitizes each user's hand that grabs the doorknob in a passive manner. As a result, the sanitizing doorknob cover device overcomes the limitations of existing doorknobs and doorknob sanitizing methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates multiple perspective views of one potential embodiment of a sanitizing doorknob cover device of the present invention in accordance with the disclosed architecture;

FIG. 2 illustrates a perspective view of one potential embodiment of a sanitizing doorknob cover device of the present invention while applied to a first doorknob style in accordance with the disclosed architecture; and

FIG. 3 illustrates a perspective view of one potential embodiment of a sanitizing doorknob cover device of the present invention while applied to a second doorknob style in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that prevents germs, viruses, and bacteria from being spread via a doorknob. There also exists a long-felt need in the art for a sanitizing doorknob cover device that sanitizes a doorknob in between uses. Further, there exists a long-felt need in the art for a sanitizing doorknob cover device that sanitizes each user's hand that grabs the doorknob. In addition, there exists a long-felt need in the art for a sanitizing doorknob cover device that operates passively. Finally, there exists a long-felt need in the art for a sanitizing doorknob cover device that fits any doorknob size and shape known in the art.

The present invention, in one exemplary embodiment, is comprised of a sanitizing doorknob cover device. The device is primarily comprised of a body having at least one disinfection compound and a first end with an opening. The body is sized and shaped to fit any style, size, and/or fit and finish of doorknob known in the art. The body has a first end with at least one opening that allows the device to be positioned and stretched over an existing doorknob. The body may also be comprised of a second end with at least one opening that allows the lock of the doorknob to be accessed while the device is applied to a doorknob.

In one embodiment, the interior surface of the body is recessed and/or ridged. This promotes grip and prevents slipping between the body and the doorknob while the device is placed over a doorknob. The interior surface may be comprised of at least one fastener that secures the interior surface of the body to the doorknob. The exterior surface may also be recessed and/or ridged to promote grip and prevent slipping between a user's hand and the device while grasping the doorknob.

The exterior surface of the body is preferably permeable. In this manner, the disinfection compound can be excreted from the body when the body is grasped by the hand of the user. In another embodiment, the compound is comprised of a coating (with at least one layer) applied to the exterior surface. However, the compound is preferably impregnated into the body (and/or exterior surface) during the manufacturing process. The compound is preferably a disinfecting compound known in the art such as, but not limited to, antibiotics, antiseptics, disinfectants, sanitizers, etc. Therefore, a user's hand is disinfected after touching the device via the transfer of the compound from the exterior surface and/or body to the user's hand. In addition, the body is also disinfected by the compound as this occurs.

Accordingly, the sanitizing doorknob cover device of the present invention is particularly advantageous as it provides a device that can be used on any doorknob to prevent germs, viruses, and bacteria from being spread via a doorknob. During use, the device sanitizes a doorknob in between uses and sanitizes each user's hand that grabs the doorknob in a passive manner. As a result, the sanitizing doorknob cover device overcomes the limitations of existing doorknobs and doorknob sanitizing methods known in the art.

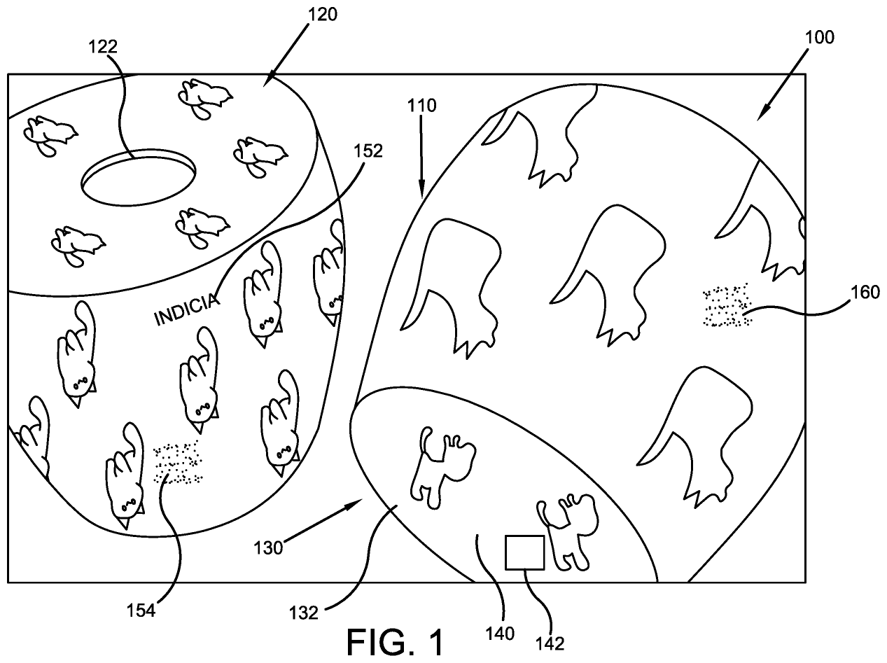

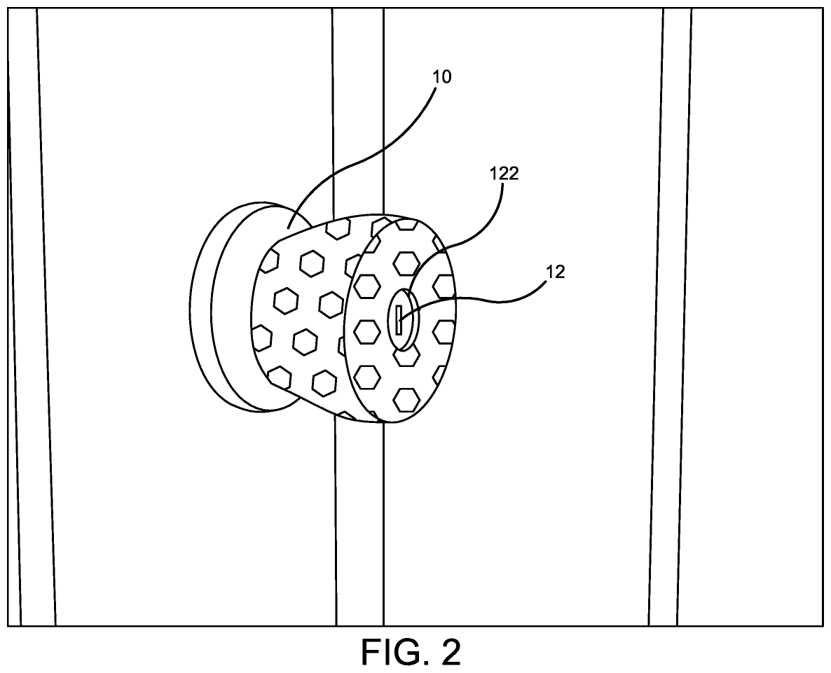

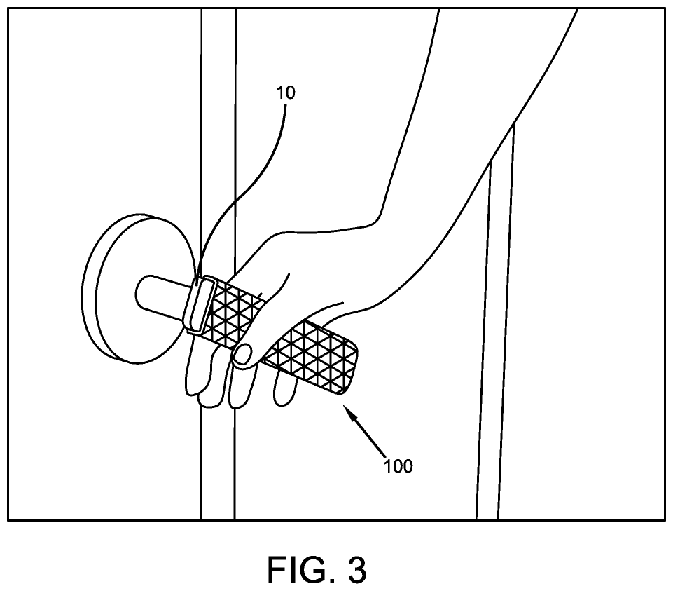

Referring initially to the drawings, FIG. 1 illustrates multiple perspective views of one potential embodiment of a sanitizing doorknob cover device 100 of the present invention in accordance with the disclosed architecture. The device 100 is primarily comprised of a body 110 having at least one disinfection compound 160 and a first end 120 with an opening 122. In the preferred embodiment, the body 110 is sized and shape to fit any style, size, fit and/or finish of doorknob 10 known in the art, as seen in FIG. 2 and FIG. 3. The body 110 is comprised of a first end 120 with at least one opening 122. The opening 122 allows the device 100 to be positioned and stretched over an existing doorknob 10. The body 110 may also be comprised of a second end 130 with at least one opening 132. The opening 132 of the second end 130 allows the lock 12 of the doorknob 10 to be accessed while the device 100 is applied to a doorknob 10, as seen in FIG. 2.

In one embodiment, the interior surface 140 of the body 110 is recessed and/or ridged to promote grip and prevent slipping between the body 110 and the doorknob 10 while the device 100 is placed over a doorknob 10. In a differing embodiment, the interior surface 140 may be comprised of at least one fastener 142 that secures the interior surface 140 of the body 110 to the doorknob 10. The fastener 142 may be any fastener known in the art such as, but not limited to, a suction cup, a magnet, a hook and loop fastener, a groove, an adhesive fastener, etc.

Similarly, the exterior surface 150 may also be recessed and/or ridged to promote grip and prevent slipping between a user's hand and the device 100 while grasping the doorknob 10. The exterior surface 150 may also be comprised of at least one indicia 152 such as, but not limited to, patterns, logos, emblems, images, symbols, designs, letters, numbers, words, characters, animals, advertisements, brands, etc. In one embodiment, the body 110 is transparent to preserve the aesthetic appearance of the doorknob 10. In other embodiment, the body 110 may be opaque or may be any color known in the art.

The device 100 is preferably made from a flexible material that can be easily affixed to and around a doorknob 10. Said materials include, but are not limited to, rubbers including Neoprene, silicone, nitrile, EPDM, Styrene-Butadiene, Butyl, natural, fluorosilicone, natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc.

The exterior surface 150 is preferably permeable such that at least one compound 160 can be excreted from the body 110 when the body 110 is grasped by the hand of the user. In another embodiment, the compound 160 is a coating 154 (with at least one layer) applied to the exterior surface 150. However, the compound 160 is preferably impregnated into the body 110 (and/or exterior surface 150) during the manufacturing process. The compound 160 is preferably a disinfecting compound known in the art such as, but not limited to, antibiotics, antiseptics, disinfectants, sanitizers, etc. In this manner, a user's hand is disinfected after touching the device 100 via the transfer of the compound 160 from the exterior surface 150 and/or body 110 to the user's hand. In addition, the body 110 is also disinfected by the compound 160 as this occurs.

In one embodiment, the material of the body 110 is heat activated, such that when a user grasps the device 100 while on a doorknob 10 the body 110 will illuminate and/or change a first color. The first color indicates the lifespan and/or the amount of compound 160 remaining in the body 110. In this manner, a user can observe the color and know when the device 100 needs replaced (i.e., when the device 100 is out of compound 160). It should be appreciated that in the preferred embodiment, the device 100 has enough compound 160 to be used for at least one month. However, the device 100 may have any amount of compound 160 to last any amount of time.

In one embodiment, the body 110 illuminates and or/changes a first color 170 when the compound 160 is at a first remaining amount. Then, the body 110 illuminates and/or changes a second color 172 when the compound 160 is at a second remaining amount. In this manner, the specific color of the body 110 can indicate to a user how much remaining compound 160 is within the body 110. In one embodiment, the first color 170 and second color 172 are lighter and/or darker shades of the same color. In another embodiment, the first color 170 and second color 172 are differing colors.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sanitizing doorknob cover device” and “device” are interchangeable and refer to the sanitizing doorknob cover device 100 of the present invention.

Notwithstanding the foregoing, the sanitizing doorknob cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the sanitizing doorknob cover device 100 as shown in the FIGS. are for illustrative purposes only, and that many other sizes and shapes of the sanitizing doorknob cover device 100 are well within the scope of the present disclosure. Although the dimensions of the sanitizing doorknob cover device 100 are important design parameters for user convenience, the sanitizing doorknob cover device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sanitizing doorknob cover device comprising:
a body that changes from a first color to a second color;
a first opening;
a second opening; and
a disinfecting compound applied to the body.

2. The sanitizing doorknob cover device of claim 1, wherein the body is comprised of a flexible material.

3. The sanitizing doorknob cover device of claim 1, wherein the body is comprised of a transparent body.

4. The sanitizing doorknob cover device of claim 1, wherein the body changes from the first color to the second color when an amount of the disinfecting compound in the body changes.

5. The sanitizing doorknob cover device of claim 1, wherein the disinfecting compound is applied to an exterior surface of the body via a layer.

6. A sanitizing doorknob cover device comprising:
a body that changes from a first color to a second color;
a first opening;
a second opening; and
a disinfecting compound impregnated within the body.

7. The sanitizing doorknob cover device of claim 6, wherein an exterior surface of the body is comprised of a recessed or a ridged exterior surface.

8. The sanitizing doorknob cover device of claim 6, wherein an interior surface of the body is comprised of a recessed or a ridged exterior surface.

9. The sanitizing doorknob cover device of claim 6, wherein the body is comprised of an indicia in the form of a pattern, a logo, an emblem, an image, a symbol, a design, a letter, a word, a character, an animal, an advertisement, or a brand.

10. The sanitizing doorknob cover device of claim 6, wherein the body is comprised of a permeable material that allows the disinfecting compound to escape the body.

11. A sanitizing doorknob cover device comprising:
a body that changes from a first color to a second color, the body comprised of a fastener;
a first opening;
a second opening; and
a disinfecting compound.

12. The sanitizing doorknob cover device of claim 11, wherein an interior surface of the body is comprised of a fastener.

13. The sanitizing doorknob cover device of claim 12, wherein the fastener is comprised of a suction cup, a magnet, a hook and loop fastener, a groove, or an adhesive fastener.

14. The sanitizing doorknob cover device of claim 11, wherein an exterior surface of the body is comprised of a permeable material.

15. The sanitizing doorknob cover device of claim 14, wherein the disinfecting compound is applied to the exterior surface.

16. The sanitizing doorknob cover device of claim 15, wherein the disinfecting compound is comprised of an antibiotic, an antiseptic, a disinfectant, or a sanitizer.

17. The sanitizing doorknob cover device of claim 11, wherein the first color corresponds to a first amount of the disinfecting compound within the body.

18. The sanitizing doorknob cover device of claim 11, wherein the second color corresponds to a second amount of the disinfecting compound within the body.

19. The sanitizing doorknob cover device of claim 11, wherein the first color and the second color are each comprised of an illuminating color.

20. The sanitizing doorknob cover device of claim 11, wherein the first color and the second color are comprised of a first shade and a second shade of a same color.
